(19) United States
(12) Patent Application Publication
(10) Pub. No.: US 2003/0224920 A1
(43) Pub. Date: Dec. 4, 2003

(54) Rotating-machine bowl assembly with flow guide

(76) Inventor: Woon-Fong Leung, Sherbon, MA (US)

Correspondence Address: R. Neil Sudol, COLEMAN SUDOL SAPONE, P.C., 714 Colorado Avenue, Bridgeport, CT, 06605-1601, US

(21) Appl. No.: 10/157,721

(22) Filed: May 28, 2002

(51) Int. Cl. B04B 1/04; B04B 1/20

(52) U.S. Cl. 494/53; 494/55; 494/66; 494/79

(57) ABSTRACT

A bowl assembly for a rotating machine includes a bowl mounted for rotation about an axis of rotation. A feed inlet or pipe is connected to the bowl for introducing a feed slurry into the bowl. The bowl also has a liquid-phase outlet. A flow guide member is disposed inside the bowl about the axis for guiding a liquid phase in an at least partially circumferential or annular path about the axis. The guide member has an outer edge spaced a predetermined distance from an inner surface of the bowl.

### BACKGROUND OF THE INVENTION

This invention relates to rotating machines of the kind used to separate heavier phases from lighter phases such as found in separating solids from a liquid phase of a suspension or slurry, a solid phase from more than one liquid phase each with a different density, a liquid phase from several solid phases each with a different density, or several liquid phases each with a different density. Such rotating machines are typically termed “centrifuges” and operate under the action of centrifugal force.

FIG. 1 shows a tubular centrifuge conventionally used in solid-liquid separation. A vertically oriented bowl 12 has a cylindrical sidewall 14 and disk shaped bowl heads 16, 18. A feed slurry or suspension is introduced into bowl 12 at 13 via a stationary feed pipe 20. The feed slurry or suspension is provided with an angular velocity through the action of feed accelerating vanes 22 at feed pipe 20. Rotation of bowl 12 about a vertical axis 24 induces the settling of solids particles in a sediment layer 26 along an inner surface 28 of bowl sidewall 14. Heavier solids have trajectories indicated by arrows 30. The liquid in a pool 32 exits bowl 12 as fluid effluent at 34. The level or height of pool 32 is controlled or determined by overflow weirs 36 disposed along bowl head 18.

Settled solids are allowed to accumulate in bowl 12 until the sediment builds up to a significant layer 26 in which the effluent liquid 34 starts to turn turbid or dirty, in which the machine is stopped and is taken apart to clean the solids out of the bowl 12 before resuming operation. Typical operating centrifugal force can be as much as 20,000-40,000 times gravity (g). The whole unit is suspended from the top with only one bearing (not shown). This rotating machine works like a spinning “top” at high speed and the axis of the rotor may gyrate to a stable operating position. Applications are polishing and clarification of liquid with low solid. Disadvantages includes the fact that solids handling is small and solids should not be hazardous for operator handling and contact during cleaning of bowl 12.

FIG. 2 diagrammatically depicts shows a prior-art tubular centrifuge for solids, light liquid and dense liquid separation. A feed slurry or suspension has heavy solids, a lighter liquid phase and an immiscible heavier liquid phase and is introduced at 37 into a bowl 38 via a feed pipe 40 and accelerated to a predetermined tangential velocity by a plurality of accelerator vanes 42. The slurry or suspension forms a pool 44 in bowl 38, with solid particles falling out along trajectories 46 to form a sediment or solid-phase layer 48 on an inner surface 50 of a cylindrical sidewall 52 of bowl 38. The light and heavy separated liquids 53 and 55 are removed at two different radii of the pool 44. The heavier liquid 55 is channeled by a baffle 54 to a chamber 56 where the heavy liquid overflows a weir 58 and forms a first effluent stream at 60, while the lighter separated liquid 53 is skimmed by a stationary pairing disc or centripetal pump 62 at the surface (not designated) of pool 44 to form a second effluent stream 64. Alternatively rotating skimming pipes can be used to skim either the light or heavy phases at their respective discharge radii.

When the solids fill bowl 38 resulting in dirty liquid streams 60 and 64, the bowl needs to be emptied. It is also to be noted that the tubular bowl shown in FIG. 2 can separate a mixture with two liquid phases without solids in which separation can be continuous without cleaning of the bowl and process interruption.

FIG. 3 schematically illustrates an automatic tubular centrifuge of the prior art, wherein the whole purification or separation process including filling of the bowl, cake removal, and bowl cleaning are fully automatic. Unlike the tubular centrifuge of FIG. 1, the centrifuge of FIG. 3 can handle more solids in the feed as the whole cycle is fully automatic. Typically 20,000 g is used in separation. A feed slurry or suspension 66 enters a bowl 68 through a feed pipe 70 and is accelerated to a predetermined tangential velocity, as indicated by arrows 72. The feed slurry forms a pool 74 in bowl 68. Solids accumulate in a layer 76 along an inner surface 78 of a cylindrical sidewall 80 of bowl 68, while a liquid effluent 82 exits the bowl at overflow weirs 84. A plurality of longitudinally spaced annular baffles 86 extend inwardly from sidewall surface 76 to stop longitudinal traveling waves in the case of long slender centrifuges operating at high centrifugal gravity, G.

When effluent 82 gets dirty, indicative that bowl 68 is filled with solids, feed slurry 66 is blocked from flow through feed pipe 70 and the machine rotation about a vertical axis 88 is slowed down. Then, a cake plow or unloader knife 89, having a comb shape to accommodate annular baffles 86, is used to scrape accumulated cake or sediment layer 76 to discharge from the machine through a solids compartment 90 which becomes accessible via gate valves 92 upon an opening thereof during a solids-discharge cycle.

The centrifuge of FIG. 3 is used in the field of biotechnology for cell harvesting, inclusion body recovery, and cell debris classification, in the pharmaceutical field for plasma fractionation, precipitate capture, vaccines and serums, and in the specialty chemical field for catalysts recovery, sub-micron classification, pigments, dyes, and toners. To avoid cross contamination in pharmaceuticals and biotech applications, clean-in-place (CIP) and sanitary-in-place (SIP) processes are practiced, using wash nozzles (not shown) to flush out residual solids hanging to walls and trapped in crevices to prevent cross contamination between batches of different products.

FIG. 4 illustrates a tubular centrifuge with a bowl 94 having a cylindrical central sidewall 96, a conical top section 98 and a conical bottom section 100. A feed suspension 102 is introduced into bowl 94 via a feed chamber 104 and is accelerated at 105 to a predetermined velocity by accelerating vanes 106 located in conical bowl section 98. The suspension forms a pool 108 in bowl 94, with clarified product or effluent 110 being slowed down at 111 by decelerating vanes 112 in conical bowl section 100 and exiting the machine via a product chamber 114. Decelerating vanes 112 decelerate the product 110 to solid-body rotation to discharge at a small radius reducing power consumption. The separation pool 108 is open with axial vanes (not shown) for stirring up sediment during shut-down. During rotation of bowl 94 about a vertical axis 1 16, solids accumulate in a sediment layer 118 along an inner surface (not separately designated) of cylindrical bowl sidewall 96. Bowl 94 is supported by both an upper bearing 120 and a lower bearing 122 and is rotated, as indicated by an arrow 124, by a drive shaft 126 connected to a center shaft 128.

### SUMMARY OF THE INVENTION

The present invention is directed to an improvement in the operation of various rotating machines used particularly in the separation of solids phases from liquid phases in slurry or suspensions. The present invention enhances centrifuge operation by providing for an increased output or enhances the quality of the separated phases for the same output.

A bowl assembly for a rotating machine comprises, in accordance with the present invention, a bowl mounted for rotation about an axis of rotation, a feed inlet connected to the bowl for introducing a feed slurry into the bowl, a liquid-phase outlet provided in the bowl, and a flow guide member disposed inside the bowl about the axis for guiding the suspension in an at least partially circumferential or annular path about the axis, the guide member having an outer edge spaced a predetermined distance from an inner surface of the bowl.

Preferably, the guide member extends along the axis from one end to an opposite end of the bowl.

In several embodiments of the present invention, the bowl has an at least partially conical sidewall. The entire sidewall of the bowl or only a portion thereof may be conical. Particularly where no active conveyor mechanism is provided for moving the cake along the inner surface of the bowl sidewall, it is preferred that a conical portion of the bowl be formed to exhibit a half conical angle greater than the angle of friction for a granular cake or a sufficiently large half angle so that fluid-like cake can flow under the component of the centrifugal gravity along the cone from the small toward the large diameter.

In one specific embodiment of the present invention, the bowl has two conical portions provided at opposite ends of the bowl. The bowl is provided with accelerating vanes in one of the conical portions at the input feed for accelerating feed liquid to a tangential speed of a pool and is further provided with liquid-decelerating vanes in the other of the conical portions to reduce power as the product liquid is channel to a small radius for discharge to reduce power consumption.

In accordance with another feature of the present invention, the flow guide may be fixed relative to the bowl and rotate at a common angular velocity therewith. In that case, the guide member may be rigidly connected to a central shaft, to the inner (circumferential) surface of the bowl, or to headers at opposite ends of the bowl.

Pursuant to a specific design, the guide member is a helical fin. The helical fin advantageously has a pitch optimized to enhance separation.

The bowl may be used in virtually any orientation. Typical orientations are horizontal and vertical. Where the bowl has a vertical orientation, the bowl may be provided with a bottom having a discharge port closure or cap temporarily openable at intervals to discharge granular non-flowable solids. In this kind of machine, the guide member may define an annular space proximate to the bottom for temporary accumulation of cake before the discharge port opens to discharge cake.

Pursuant to another feature of the present invention, a conveyor is disposed in the bowl for moving the deposited solids along the inner surface of the bowl. During operation of the rotating machine, the conveyor rotates at a different speed than the bowl to transport deposited cake solids down an annular path formed between the guide member and the inner surface of the bowl. The conveyor may take the form of a ribbon conveyor, which is disposed at a radial distance (from the rotation axis) greater than the distance of the guide member from the axis.

The guide member and the conveyor may be integrally formed for directing flow to enhance centrifugal separation and for conveying cake along the bowl toward a discharge outlet port.

In alternative embodiments of the present invention, the guide member is either rotatably mounted to the bowl for rotation relative to the bowl or fixed relative to the bowl. In the latter case, the guide member may be mounted directly (a) to bowl heads respectively located at opposite ends of the bowl, (b) to a shaft disposed in the bowl coaxially with the axis, or (c) to the inner surface of the bowl, for instance, by studs.

The path defined by the flow guide member typically has a circumferential or annular component and an axial or longitudinal component, as where the guide member takes the form of a spiral. Preferably, the circumferential or annular component is larger than the axial or longitudinal component.

Where the rotating machine incorporating the bowl assembly of the present invention operates in a continuous rather than a batch mode, the bowl may be provided with a plurality of solid-phase discharge ports disposed at axially spaced locations in the bowl. Typically, a first plurality of circumferentially spaced cake discharge ports or nozzles are located at one axial position, for instance, at a downstream end of the bowl, while a second plurality of circumferentially spaced cake discharge ports or nozzles are located at an intermediate axial location, spaced from the opposite ends of the bowl.

In another embodiment of the present invention, baffles are disposed in the bowl along the guide member to force the liquid phase to flow substantially circumferentially in a predetermined direction.

Pursuant to another feature of the present invention, the bowl assembly further comprises a plurality of rakes disposed in the bowl for rotating at a differential speed relative to the bowl to propel and agitate deposited solids to induce same to flow down an annular path formed between the guide member and the inner surface of the bowl. Another important function of the flow guide is that it blocks longitudinal (along axis) traveling waves from propagating that can be damaging especially under high-speed rotation.

A decanter centrifuge with a flow guide in accordance with the present invention is simpler and less expensive to manufacture and operate than conventional machines, having a cake conveyor that moves at a differential speed relative to the centrifuge bowl. This omission of a conveyor results in a reduction in manufacturing expense in part because no gearbox or backdrive is necessary. Moreover, bearing design is simplified. The omission of a conveyor also results in a reduction in operating expense since the power requirement is reduced: no conveyance power, thus there are fewer moving parts and a reduced requirement for repair and maintenance procedures.

In a decanter-type centrifuge in accordance with the present invention, used for classification or fractionating a suspension into a product stream containing valuable fine particles and a reject stream containing oversize, coarse particles, the feed suspension continuously drops out coarse solids, flows around the helical fin to the overflow weir whereas the coarse reject flows down an annular path along a cone angle driven by a component of the G-force to nozzle discharge locations. More pool volume is provided for separation, since the shaft (if any) supporting the flow guide may be thinner than the shaft necessary for supporting a conveyor screw. The deep pool design, with longer retention time, further enhances classification.

There are other advantages of a decanter design in accordance with the present invention.

With the new invention of a conical bowl, the cake can be discharged continuously, and the “opened” flow guide can stop traveling waves and enhances sedimentation. This is especially favorable at high rotation speed and high G.

### BRIEF DESCRIPTION OF THE DRAWINGS

FIG. 1 is a schematic longitudinal cross-sectional view through a bowl assembly of a prior-art centrifuge.

FIG. 2 is a schematic longitudinal cross-sectional view through a bowl assembly of another prior-art centrifuge.

FIG. 3 is a schematic longitudinal cross-sectional view through a bowl assembly of a further prior-art centrifuge.

FIG. 4 is a schematic longitudinal cross-sectional view through a bowl assembly of yet another prior-art centrifuge.

FIG. 5 is a schematic longitudinal cross-sectional view through a bowl assembly of a centrifuge in accordance with the present invention.

FIG. 6 is a schematic longitudinal cross-sectional view through a bowl assembly of another centrifuge in accordance with the present invention.

FIG. 7 is a schematic longitudinal cross-sectional view through a bowl assembly of a further centrifuge in accordance with the present invention.

FIG. 8A is a schematic longitudinal cross-sectional view through a bowl assembly of an additional centrifuge in accordance with the present invention, showing the centrifuge in one mode of operation.

FIG. 8B is a schematic longitudinal cross-sectional view similar to FIG. 8A, showing the centrifuge of that figure in another mode of operation.

FIG. 9 is a schematic longitudinal cross-sectional view through a bowl assembly of yet another centrifuge in accordance with the present invention.

FIG. 10 is a schematic longitudinal cross-sectional view through a bowl assembly of yet a further centrifuge in accordance with the present invention.

FIG. 11 is a schematic longitudinal cross-sectional view through a bowl assembly of a modification of the centrifuge of FIG. 10, in accordance with the present invention.

FIG. 12 is a diagram showing a bowl and rakes of FIG. 11 in a developed or rolled out configuration, represented by arrows A-A in FIG. 11.

FIG. 13 is a schematic longitudinal cross-sectional view through a bowl assembly of another modification of the centrifuge of FIG. 10, in accordance with the present invention.

FIG. 14 is a graph of solids-capture performance, comparing a centrifuge with a flow guide in accordance with the present invention and a conventional centrifuge without such a flow guide.

FIG. 15A is a schematic partial longitudinal cross-sectional view of a bowl assembly with a profiled flow guide in accordance with the present invention.

FIG. 15B is a schematic partial longitudinal cross-sectional view of a bowl assembly with another profiled flow guide in accordance with the present invention.

FIG. 16 is a cross section along the streamwise direction of a flow guide in accordance with the present invention, showing a gate arrangement to alter the flow path of the feed suspension in the course of flowing toward the effluent liquid discharge.

In the drawings, like parts are designated with the same reference numbers.

### DEFINITIONS

The phrase “an at least partially circumferential or annular path” is used herein to denote a path that has at least one path segment with a circumferential or annular component. Thus, a quantity of fluid traveling along that path segment has a velocity vector with a circumferential or annular component. A spiral path is an example of an at least partially circumferential or annular path.

The phrase “an at least partially helical path” is used herein to denote a path that has at least one path segment with a circumferential or annular component and an axial or longitudinal component. Thus, a quantity of fluid traveling along that path segment has a velocity vector with a circumferential or annular component and an axial or longitudinal component.

The term “bowl” is used herein to denote a rotatable outer casing of a rotating machine. A bowl, as that term is used herein, may include both bowl heads and a sidewall. Solid phase outlets are typically provided in the sidewall, whereas liquid phase outlets are generally located in a bowl head. However, the arrangement of outlets may be different, as where a liquid phase is siphoned off via a pipe or tube extending through the sidewall. The sidewall of a bowl may be completely imperforate or partially perforated, as in the case of a screen bowl.

A “guide member” or “flow guide” as that term is used herein refers to any physical structure capable of deflecting and directing flow. A guide member may take the form of a baffle, a fin, or a vane, or any other form suitable for controlling the direction of fluid flow. A guide member or flow guide as disclosed herein directs a suspension in a pool of a centrifuge or rotating machine at least partially and preferably substantially in a circumferential or annular direction. A guide member or flow guide in accordance with the present disclosure may be a continuous structure or may be a segmented or interrupted structure. For instance, a guide member or flow guide may be a plurality of helical fins spaced from one another along an axis of a rotating machine. In addition, a guide member or flow guide as disclosed herein may extend throughout the length of a bowl or alternatively may extend only along part of the bowl length.

The term “suspension” or “slurry is used herein to describe a flowable composition that contains components (phases) of different densities. For example, a suspension may be a liquid that contains solid particulate material. Alternatively, a suspension may be a mixture of two or more liquids of different densities, with or without particulate material. The term “suspension” thus encompasses both a feed slurry or liquid-solids suspension after introduction thereof into a rotating bowl and the liquid portion of the slurry after separation or settling of at least some of the solids contained in the slurry. The amount of solids in the suspension varies from a highest concentration at a feed input to a lowest concentration at a liquid phase discharge port. More generally, the word “suspension” encompasses a flowable mixture of components of different densities where the concentration or amount of a heavy phase varies from a highest concentration at a feed input to a lowest concentration at a light phase discharge port. Where solids of a suspension are deposited under the action of centrifugal force on the inner cylindrical and/or conical surface of the bowl, the solid-phase material mixed with a residual amount of liquid is frequently termed “cake” and may be removed automatically in a continuous process through one or more solids-phase discharge ports. Cakes vary in consistency from granular to pasty.

### DETAILED DESCRIPTION OF THE PREFERRED EMBODIMENTS

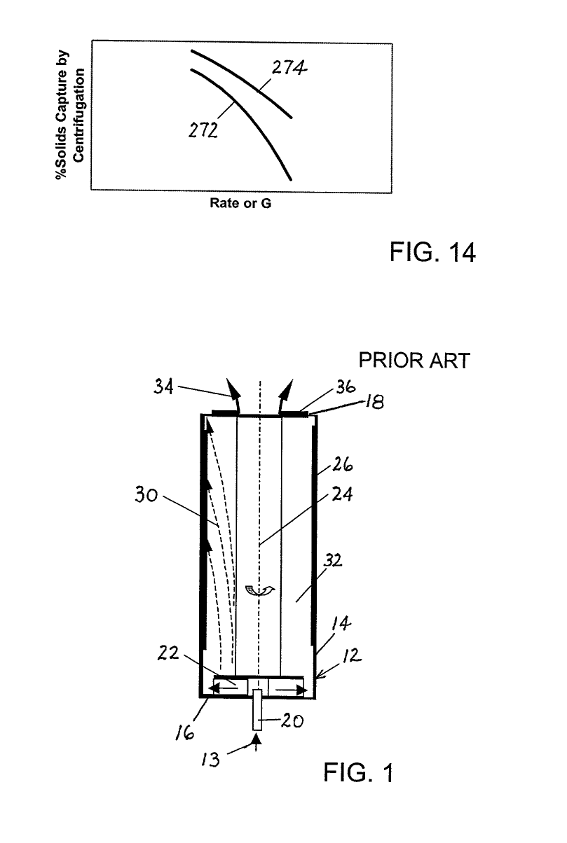

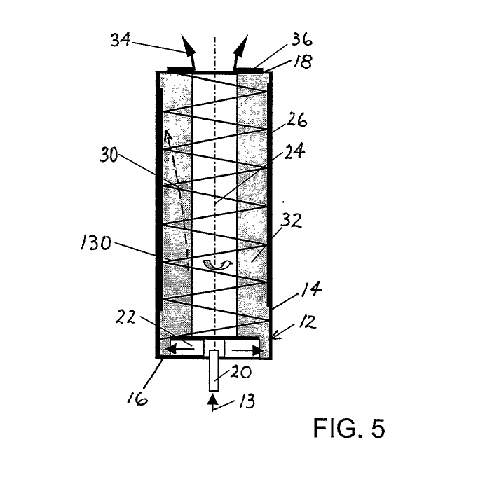

FIG. 5 illustrates a modification in the bowl assembly of FIG. 1. Bowl 12 is provided with a flow guide member 130 in the form of a helical fin extending the entire length of the bowl, from bowl head 16 to bowl head 18. Guide fin 130 ensures that the solids-carrying liquid phase, with a solids concentration varying from a high at the input end to a low at the output end, travels along a substantially circumferential or annular path inside bowl 12. Guide fin 130 is preferably fixed relative to bowl 12 and rotates at the same angular velocity as the bowl. Fin 130 may be fixed to inner surface 28 of bowl 12 via spaced studs (not shown). Alternatively or additionally, fin 130 may be fixed to a central shaft (not shown) and/or to bowl heads 16 and 18. Preferably, fin 130 has a spiraling outer edge (not separately designated) that is spaced a predetermined distance from inner surface 28 of bowl 12. This spacing facilitates the removal of sediment layer 26 from bowl sidewall 14. Fin 130 advantageously has a pitch optimized to enhance separation.

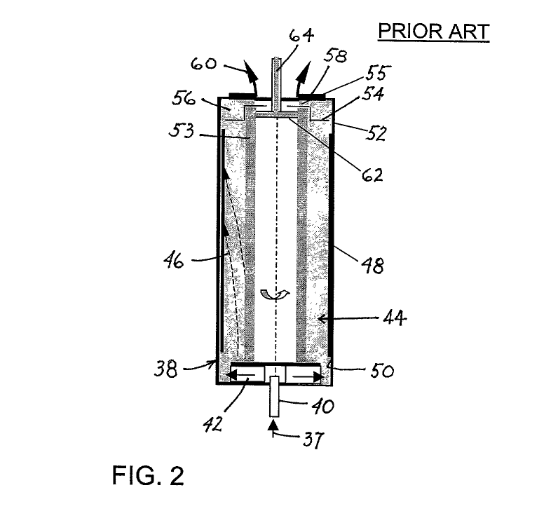

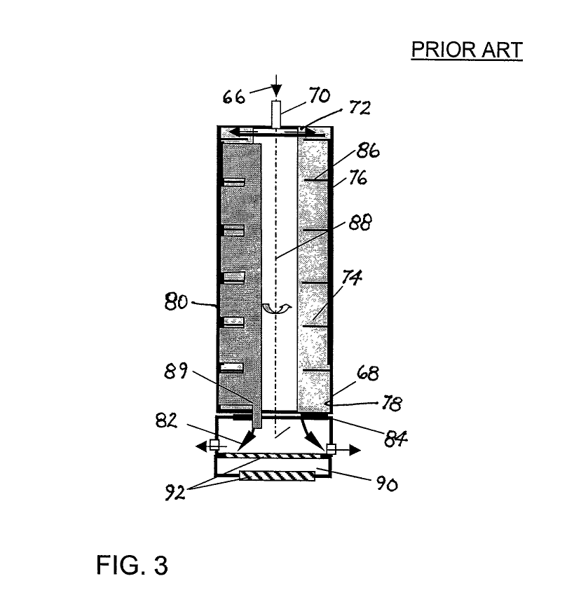

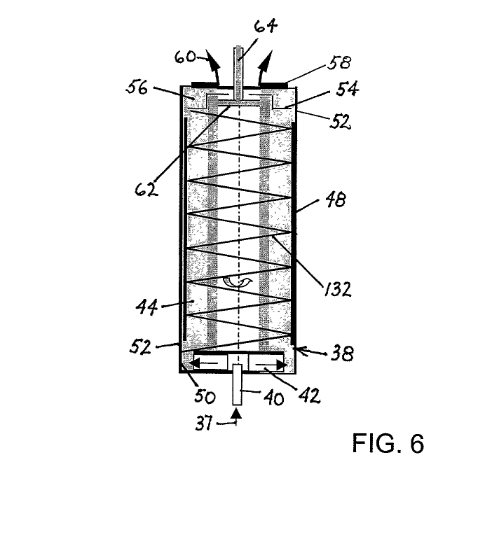

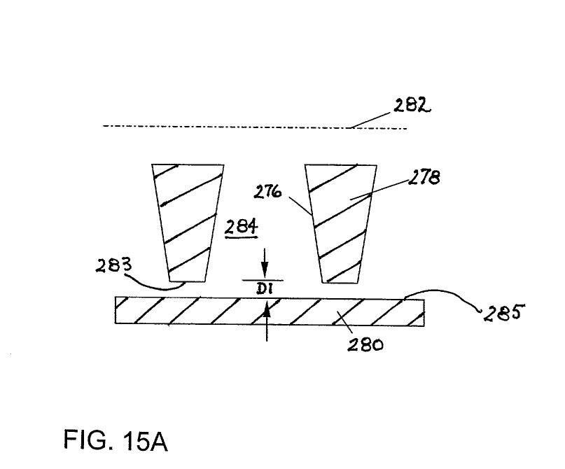

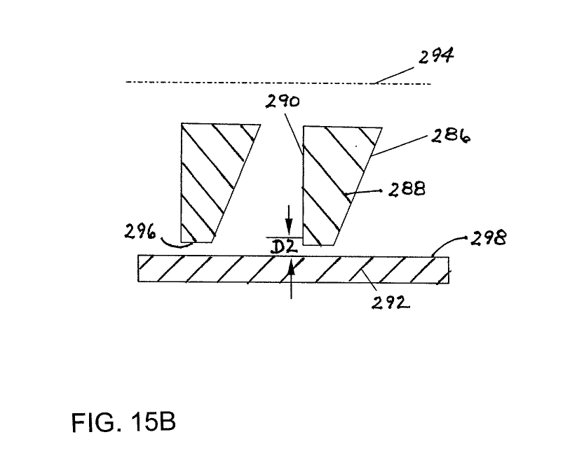

FIG. 6 depicts an improvement in the bowl assembly of FIG. 2. Bowl 38 is provided with a flow guide member 132 in the form of a helical fin extending the entire length of the bowl, from accelerator vanes 142 at an input end to baffle 54 and pairing disc or centripetal pump 62 at an output end. Guide fin 132 constrains the solids carrying liquid phase to move along a substantially circumferential or annular path inside bowl 38. The ratio of a circumferential or annular component of the path to an axial or longitudinal component may be increased by decreasing the pitch of the fin flights. This is generally desirable as the degree of solids separation is augmented where the travel path of the liquid phase is more annular than longitudinal. Under some conditions, the pitch of the guide fin may increase to achieve other objectives such as to reduce side-wall friction to flow. Also the adjacent side wall of the guide fins may not need to be parallel as in conventional decanter centrifuge, the side walls can be angled with increasing width either radially inward or radially outward as shown, respectively, by FIG. 15A and FIG. 15B to change the effective channel width opened to flow in the fin. Guide fin 132 is preferably fixed relative to bowl 38 and rotates at the same angular velocity as the bowl. Fin 132 may be fixed directly to inner surface 50 of bowl 38 via spaced studs (not shown). Alternatively or additionally, fin 132 may be fixed to a central shaft (not shown) and/or to bowl heads (not separately designated). Preferably, fin 132 has a spiraling outer edge (not separately designated) that is spaced a predetermined distance from inner surface 50 of bowl 38. This spacing facilitates the removal of sediment layer 48 from bowl sidewall 52.

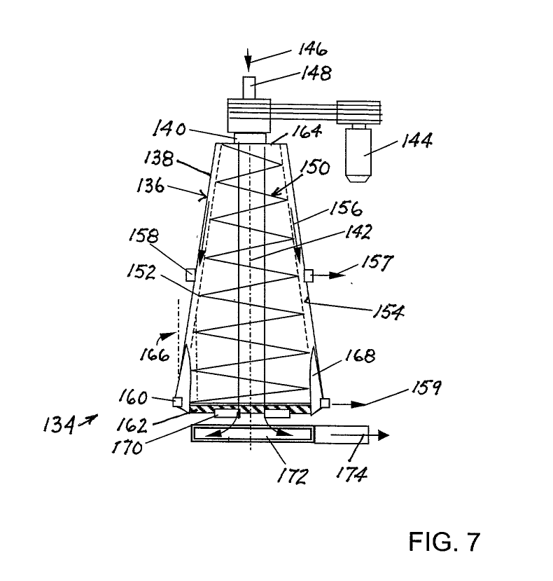

As shown in FIG. 7, a centrifuge bowl assembly 134 comprises a conical bowl 136 having an entirely conical sidewall 138. Bowl 136 is supported at only an upper end by a bearing 140 and is rotated about an axis 142 by a motor 144. A feed slurry or suspension 146 enters bowl 136 through a feed pipe 148 at the upper end of the bowl. A flow guide member 150 in the form of a helical fin extends the entire length of bowl 136. Guide fin 150 constrains the suspension to move along a substantially circumferential or annular path inside bowl 136. Guide fin 150 has a spiraling outer edge 152 which is spaced a predetermined distance from an inner surface 154 of sidewall 138 to define therewith a cake flow path 156. Solids that are deposited in a cake layer (not shown) on inner surface 154 during rotation of bowl 136 about axis 142 flow on inner surface 154 along path 156, from a narrow-diameter end of bowl 136 towards a large-diameter end thereof. Path 156 is oriented at a substantial angle to the flights of guide fin 150, rather than parallel to the major surfaces (not designated) of the guide fin. In contrast to the suspension path, which is defined by guide fin 150 to have a substantial circumferential or annular component, the cake path 156 is mostly, if not entirely, longitudinal. The cake exits the bowl in continuous streams 157 and 159 at an intermediate axial location through a first series of circumferentially spaced outlet nozzles 158 and at a terminal axial location through a second series of circumferentially spaced outlet nozzles 160.

Guide fin 150 may be rotatably mounted to bowl 136 for rotation relative thereto. Preferably, however, guide fin 150 is fixed relative to the bowl. In that case, guide fin may be mounted directly (a) to bowl heads 162 and 164 respectively located at opposite ends of bowl 136, (b) to a shaft (not shown) disposed in the bowl coaxially with rotation axis 142, or (c) to inner surface 154 of bowl sidewall 138, for instance, by studs (not shown).

Bowl sidewall 138 exhibits a half angle 166 such as to ensure fluid-like cake flows down the path 154 toward the large bowl diameter. Guide fin 150 is profiled at the large diameter end of bowl 136 to form a temporary storage space 168 for cake a discharge thereof through lower outlet nozzles 160.

Effluent liquid of a low solids concentration overflows weirs 170 at large-diameter head 162 and enters a stationary effluent catcher 172 for subsequent discharge, as indicated by an arrow 174.

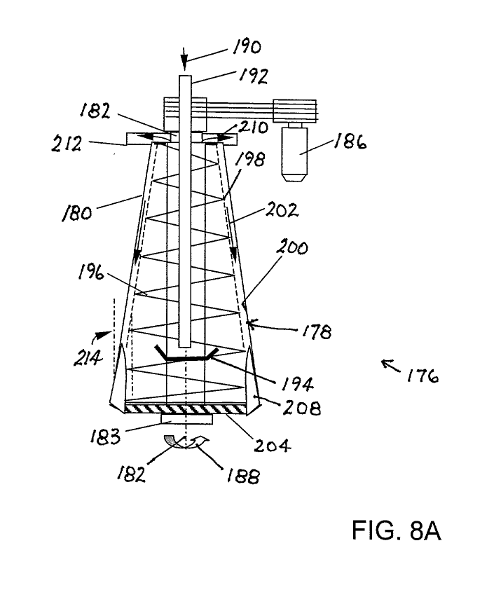

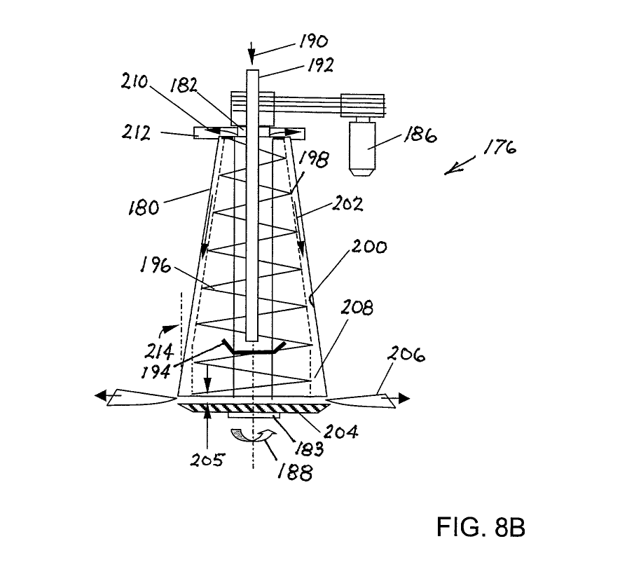

FIGS. 8A and 8B illustrate another conical bowl assembly 176 for a rotating solid-liquid separation machine. Bowl assembly 176 comprises a conical bowl 178 having an entirely conical sidewall 180. Bowl 178 is supported at an upper end by a bearing 182 and at a lower end by another bearing 183 and is rotated about an axis 184 by a motor 186, as indicated by an arrow 188. A feed slurry or suspension 190 enters bowl 178 through a feed pipe 192 that extends along axis 184 through bowl 178 to a deflector or distributor 194. (Feed pipe 192 can be rotating in high-speed centrifuges. However, feed pipe 192 cannot exceed a certain length because otherwise it will experience vibration because the rotation speed exceeds the natural frequency of the pipe. One solution is to have a fixed portion followed by a rotating portion.)

As further illustrated in FIGS. 8A and 8B, a flow guide member 196 in the form of a helical fin extends the entire length of bowl 178. Guide fin 196 constrains the suspension to move along a substantially circumferential or annular path inside bowl 178. Guide fin 196 has a spiraling outer edge 198 which is spaced a predetermined distance from an inner surface 200 of sidewall 180 to define therewith a cake flow path 202. Solids that are deposited in a cake layer (not shown) on inner surface 200 during rotation of bowl 178 about axis 184 flow on inner surface 200 along path 202, from a narrow-diameter end of bowl 178 towards a large-diameter end thereof. Path 202 is oriented at a substantial angle to the flights of guide fin 196, rather than parallel to the major surfaces (not designated) of the guide fin. In contrast to the liquid phase path, which is defined by guide fin 196 to have a substantial circumferential or annular component, the cake path 202 is mostly, if not entirely, axial or longitudinal along the cone.

Bowl 178 is provided with a movable bottom panel or discharge closure head 204 which is usually in a closed position as shown in FIG. 8A. Bottom panel or discharge closure head 204 is temporarily opened (FIG. 8B) at intervals to form a gap 205 discharge granular non-flowable solids in an output flow 206. The solids accumulate in an annular storage space 208 defined proximate to bottom panel or discharge closure head 204 by guide fin 196. Typically, the intermittent actuation of bottom panel or discharge closure head 204 is hydraulic. The frequency of opening of the bottom panel or discharge closure head 204 for cake discharge can be set for fixed time interval control or actuated by pressure (indicative the cake storage area is filled) as with disk centrifuges. Effluent liquid 210 exits bowl 178 at an upper end, proximate to bearing 182, and is temporarily held in an effluent catcher 212 prior to final discharge.

Guide fin 196 may be rotatably mounted to bowl 178 for rotation relative thereto. In the illustrated embodiment, guide fin 196 is fixed relative to the bowl. Fin 196 may be mounted directly to a shaft (not shown) disposed in the bowl coaxially with rotation axis 184 and/or to inner surface 200 of bowl sidewall 180, for instance, by studs (not shown).

Bowl sidewall 180 exhibits a half conical angle 214 greater than the angle of friction for a granular cake. The half angle 214 needs to be large to ensure the cake flows down the path 202 toward the large bowl diameter.

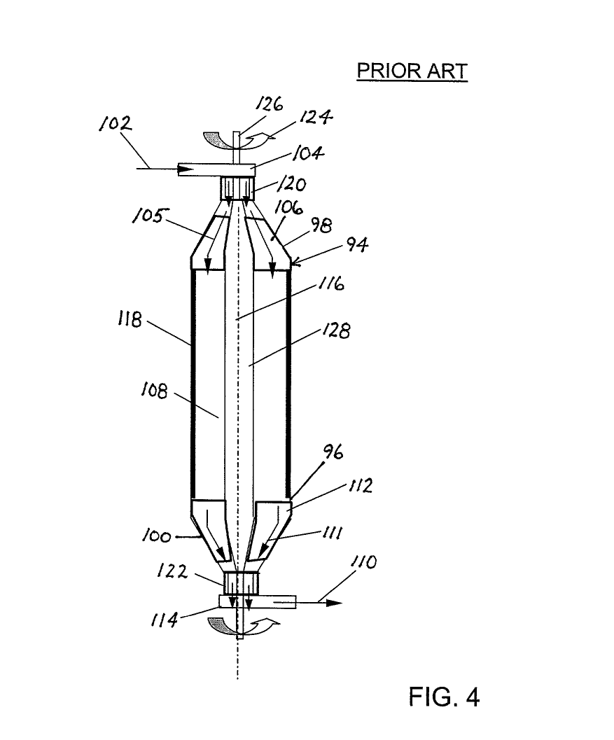

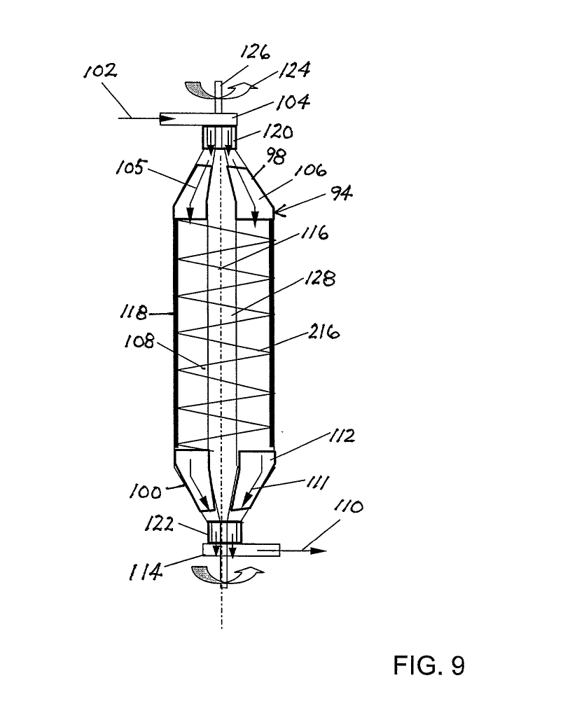

FIG. 9 depicts an improvement in the bowl assembly of FIG. 4. Bowl 94 is provided with a helical fin 216 extending the length of cylindrical sidewall section 96, from conical bowl section 98 at an input end to conical bowl section 100 at an output end. Guide fin 216 guides the liquid phase or suspension fluid to move along a substantially circumferential or annular path inside bowl 94. Guide fin 216 is preferably fixed relative to bowl 94 so as to rotate at the same angular velocity. Fin 216 may be fixed directly to bowl sidewall 96 via spaced studs (not shown) and/or to an axial shaft (not shown). Preferably, fin 216 has a spiraling outer edge (not separately designated) that is spaced a predetermined distance from inner surface 50 of bowl sidewall 96 to facilitate the removal of sediment layer 118 from bowl sidewall 96

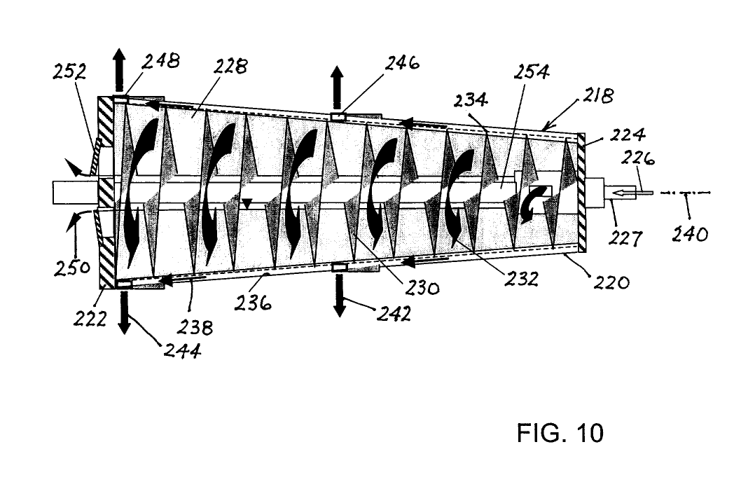

FIG. 10 shows a horizontally oriented conical centrifuge bowl 218 comprising a conical sidewall 220 and a pair of disk-shaped bowl heads 222 and 224 at opposite ends of the sidewall. A slurry 226 is introduced into bowl 218 via a feed pipe 227 traversing head 224 and forms a separation pool 228 in bowl 218. A flow guide member 230 in the form of a helical fin extends the entire length of bowl 218. Guide fin 230 constrains the liquid phase in pool 228 to move along a substantially circumferential or annular path 232 inside bowl 218. Guide fin 230 has a spiraling outer edge 234 which is spaced a predetermined distance from an inner surface 236 of sidewall 220 to define therewith a cake flow path 238. Solids that are deposited in a cake layer (not shown) on inner surface 236 during rotation of bowl 218 about a horizontal axis 240 flow on inner surface 236 along path 238, from a narrow-diameter end of bowl 218 towards a large-diameter end thereof. Path 238 is oriented at a substantial angle to the flights of guide fin 230, rather than parallel to the major surfaces (not designated) thereof. In contrast to the liquid phase path, which is defined by guide fin 230 to have a substantial circumferential or annular component, the cake path 238 is mostly, if not entirely, axial or longitudinal. The cake exits the bowl 218 in continuous streams 242 and 244 at an intermediate axial location through a first series of circumferentially spaced outlet nozzles 246 and at a terminal axial location through a second series of circumferentially spaced outlet nozzles 248. The liquid phase exits bowl 218 in effluent streams 250 passing over weirs 252 in head 222.

Guide fin 230 is mounted to an axial shaft 254. Preferably, shaft 254 and guide fin 230 are stationary relative to bowl 218 and thus rotate at a common velocity therewith. Alternatively, guide fin 230 may be mounted directly to bowl heads 222 and 224 or to inner surface 236 of bowl sidewall 220, for instance, by studs (not shown).

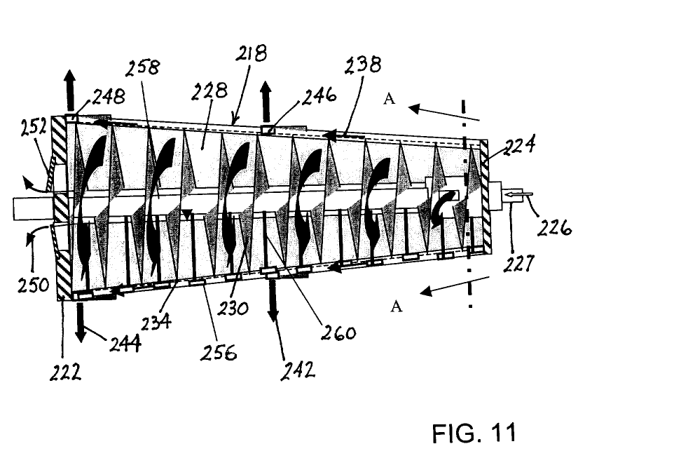

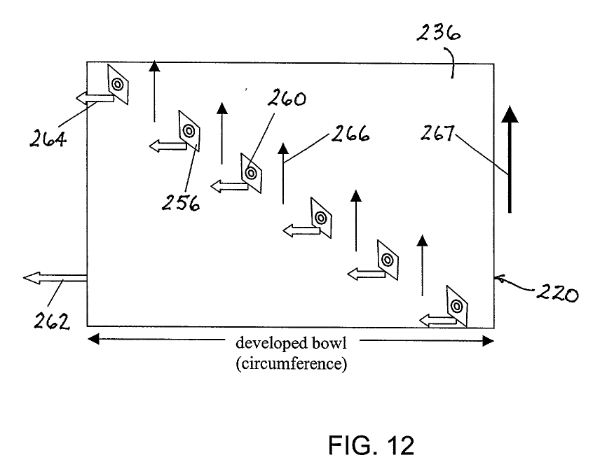

FIGS. 11 and 12 show a modification of the centrifuge of FIG. 10 in which plural rake elements 256 are disposed in bowl 218 for stirring the cake and breaking up any clumps on sidewall inner surface 236 to ensure flowability of the deposited cake solids. Rake elements 256 are connected to a conveyor hub 258 via respective rigid posts 260 for moving at a different angular velocity than bowl 218. In the developed view of FIG. 12, arrow 262 represents the bowl speed, while arrows 264 represent the speed of rake elements 256. Arrows 266 represent the cake flow along inner surface 236 of bowl sidewall 220. Arrow 267 is the longitudinal direction along the bowl 218 toward the large diameter end.

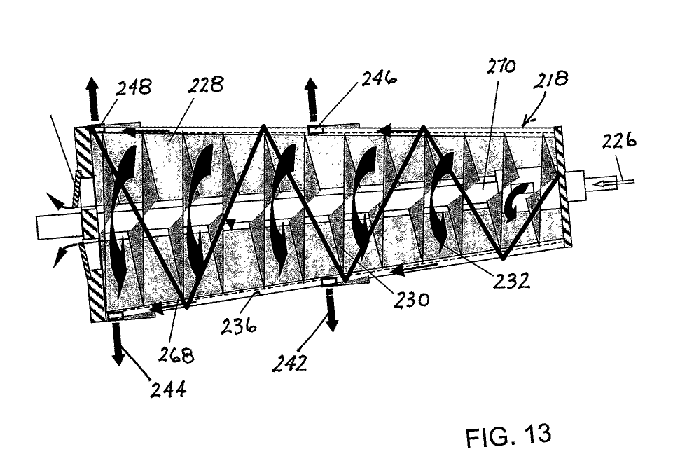

FIG. 13 depicts another modification of the centrifuge of FIG. 10 wherein a sediment conveyor 268 is provided in bowl 218 for transporting deposited cake sediments along inner surface 236 of bowl sidewall 220. Conveyor 268 is mounted to a hub 270 for rotation at a different angular speed than bowl 218.

FIG. 14 shows a pair of graphs comparing the percentage of solids recovery by centrifugation in a conventional centrifuge (graph 272) with the percentage of solids recovery by centrifugation in a centrifuge having a flow guide as described herein (graph 274). The flow guide works well with high speed and high G centrifugation, for instance, 5000-20,000 g, such as using in tubular (manual and automatic) centrifuges for biotech, pharmaceutical, and specialty chemicals. The flow guide enables superior performance as shown in FIG. 14 for the same G or same rate or same performance but with a higher rate. In fact, it is expected that high speed would only further bring out the enhancement of the flow guide in separation. Also, a flow guide as described herein may be used in some of the disk centrifuge applications such as oil-water separation, polishing, clarification and separation of solid-liquid, liquid-liquid, or solidliquid-liquid.

FIG. 15A shows a slanting side wall or surface 276 of a fin or flow guide 278 disposed in a bowl 280 rotating about an axis 282. An outer edge 283 of fin 278 is spaced a predetermined distance D1 from an inner surface 285 of bowl 280 to permit axially directed cake flow. Slanting surface 276 results in a wider channel 284 between adjacent wraps at the large radius as compared with at the small radius or when compared with a fin which has a straight sidewall (not shown) with the same pitch. The reverse is true (not shown) when the slanting surface reverses in orientation with respect to the radial direction.

FIG. 15B shows a slanting wall or surface 286 on one face of a fin 288 having a straight or planar surface 290 on the opposite face. Fin 288 is disposed in a bowl 292 rotating about an axis 294. An outer edge 296 of fin 288 is spaced a predetermined distance D2 from an inner surface 298 of bowl 292 to permit axially directed cake flow. Both designs as depicted in FIGS. 15A and 15B are used for directing flow and changing the cross sectional area opened to flow at, respectively, the small and large radius locations to obtain the most optimal result for separation.

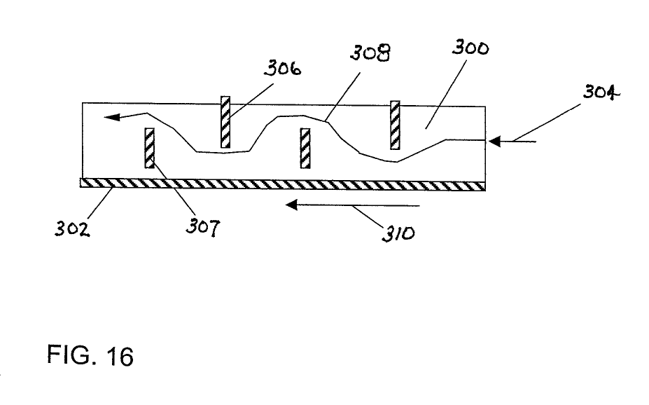

FIG. 16 depicts a circumferentially extending flow guide or fin 300 in a bowl 302 shown in a developed view along the flow-stream direction. The flow guide or fin defines a substantially circumferential flow channel having an inlet 304 and a general direction of flow 310. One or more gates 306, 307 are so disposed in the flow channel as to extend substantially perpendicularly to the flow path defined by the channel. Gates 306, 307 serve to direct the flow 308 of a suspension either radially inward or radially outward, so that the velocity of the lighter phase and suspension in the circumferential direction is optimized and the volume of sweep in the pool is more uniform. The design and location of gates 306, 307 are arranged to improve the separation of the suspension. These gates 306, 307 are part of the flow guide or fin 300 and thus rotate at the same speed as the flow guide. (Gates 306, 307 are different from baffles that are more circumferentially or axially oriented, parallel to the streamwise direction to direct the flow either axially or circumferentially. In contrast, gates 306, 307 are more radially oriented and perpendicular to the streamwise direction to redirect the flow radially in-and out as the flow moves through the flow guide channel.)

Although the invention has been described in terms of particular embodiments and applications, one of ordinary skill in the art, in light of this teaching, can generate additional embodiments and modifications without departing from the spirit of or exceeding the scope of the claimed invention. For example, one skilled in the art will appreciate that the orientation of the rotating bowl and the rotation axis is not relevant to the invention. The bowl may rotate about an axis having essentially any orientation, even though only horizontal and vertical orientations are specifically disclosed herein. Accordingly, it is to be understood that the drawings and descriptions herein are proffered by way of example to facilitate comprehension of the invention and should not be construed to limit the scope thereof.

What is claimed is:

1. A bowl assembly for a rotating machine, comprising:
a bowl mounted for rotation about an axis of rotation;
a feed inlet connected to said bowl for introducing a feed slurry into said bowl;
a liquid-phase outlet provided in said bowl; and
a flow guide member disposed inside said bowl about said axis for guiding a suspension in an at least partially circumferential or annular path about said axis, said guide member having an outer edge spaced a predetermined distance from an inner surface of said bowl.

2. The bowl assembly defined in claim 1 wherein said guide member extends generally along said axis from approximately one end to approximately an opposite end of said bowl.

3. The bowl assembly defined in claim 2 wherein said bowl has an at least partially conical sidewall.

4. The bowl assembly defined in claim 3 wherein a conical portion of said bowl has a half conical angle greater than the angle of friction for a granular cake.

5. The bowl assembly defined in claim 2 wherein said guide member is fixed relative to said bowl and rotates at a common angular velocity therewith.

6. The bowl assembly defined in claim 2 wherein said guide member is a helical fin.

7. The bowl assembly defined in claim 1 wherein said bowl has an at least partially vertical orientation, said bowl having a bottom provided with a discharge port with a closure temporarily openable at intervals to discharge granular non-flowable solids.

8. The bowl assembly defined in claim 7 wherein said guide member defines an annular space proximate to said bottom for temporary accumulation of cake before said discharge port opens to discharge cake.

9. The bowl assembly defined in claim 1 wherein said bowl has two conical portions provided at opposite ends of said bowl.

10. The bowl assembly defined in claim 9 wherein said bowl is provided with accelerating vanes in one of said conical portions at said input feed for accelerating feed slurry to a tangential speed of a pool and is further provided with liquid-decelerating vanes in said other of said conical portions to reduce power as the product liquid is channel to a small radius for discharge to reduce power consumption.

11. The bowl assembly defined in claim 1, further comprising a ribbon conveyor for transporting sediment along said inner surface of said bowl, said ribbon conveyor being located at a radial distance greater than that of said guide member and rotated at differential speed compared with said bowl.

12. The bowl assembly defined in claim 11 wherein said conveyor is attached to an outer periphery of said guide member so that said guide member and said conveyor rotate at the same angular speed, yet at a differential speed compared with the bowl.

13. The bowl assembly defined in claim 1 wherein said guide member is a helical fin.

14. The bowl assembly defined in claim 13 wherein said fin has a pitch optimized to enhance separation.

15. The bowl assembly defined in claim 1, further comprising a conveyor disposed in said bowl for rotating at a differential speed relative to said bowl to transport deposited cake solids down an annular path formed between said guide member and said inner surface of said bowl.

16. The bowl assembly defined in claim 15 wherein said guide member and said conveyor are integral for directing flow to enhance centrifugal separation and for conveying cake (solids) along said bowl toward a discharge outlet port.

17. The bowl assembly defined in claim 1 wherein said guide member is rotatably mounted to said bowl for rotation relative to said bowl.

18. The bowl assembly defined in claim 1 wherein said guide member is fixed relative to said bowl and rotates at a common angular velocity therewith.

19. The bowl assembly defined in claim 1 wherein said bowl has an orientation taken from the group comprising substantially horizontal and substantially vertical.

20. The bowl assembly defined in claim 1 wherein said path has a circumferential or annular component and an axial or longitudinal component, said circumferential or annular component being larger than said axial or longitudinal component.

21. The bowl assembly defined in claim 1, further comprising a plurality of solid-phase discharge ports disposed at axially spaced locations in said bowl.

22. The bowl assembly defined in claim 1 wherein baffles are disposed in said bowl along said guide member to force the suspension to flow substantially circumferentially in a predetermined direction.

23. The bowl assembly defined in claim 1 wherein said bowl is substantially conical.

24. The bowl assembly defined in claim 1 wherein said bowl has a plurality of nozzles disposed at a common axial location and spaced uniformly circumferentially for discharging flowable cake.

25. The bowl assembly defined in claim 1 wherein said bowl has a plurality of nozzles located at respective axial locations along said bowl for discharging flowable cake.

26. The bowl assembly defined in claim 1, further comprising a plurality of rakes disposed in said bowl for rotating at a differential speed relative to said bowl to propel and agitate deposited solids to induce same to flow down an annular path formed between said guide member and said inner surface of said bowl.

27. The bowl assembly defined in claim 1 wherein said guide member is mounted from the two bowl heads respectively located at opposite ends of said bowl.

28. The bowl assembly defined in claim 1 wherein said guide member is fixed to a shaft disposed in said bowl coaxially with said axis.

29. The bowl assembly defined in claim 1 wherein said guide member is fixed to said inner surface of said bowl by studs.

30. The bowl assembly defined in claim 1 wherein the feed slurry consists of two liquids with different densities, a separated light liquid being discharged at said light-phase outlet and a heavy liquid phase being discharged at an additional light-phase outlet.

31. The bowl assembly defined in claim 1 wherein the feed slurry consists of two solids and one liquid all with different densities.

32. The bowl assembly defined in claim 1 wherein the feed slurry consists of two liquids and one solid all with different densities.

33. The bowl assembly defined in claim 1 wherein said guide member has at least one inclined surface to define a flow channel with a radially outer width different from the radially inner width.

34. The bowl assembly defined in claim 1, further comprising at least one baffle disposed in a suspension-flow channel in said bowl in an orientation to direct flow of the suspension in an at least partially radial direction along said flow channel.

35. A bowl assembly for a rotating machine, comprising:
a bowl mounted for rotation about an axis of rotation;
a feed inlet connected to said bowl for introducing a feed slurry into said bowl;
a liquid-phase outlet provided in said bowl; and
a guide member disposed inside said bowl about said axis for guiding a suspension in an at least partially circumferential or annular path about said axis, said guide member being fixed relative to said bowl to rotate at even angular speed therewith about said axis.

36. The bowl assembly defined in claim 35 wherein said guide member extends along said axis from one end to an opposite end of said bowl.

37. The bowl assembly defined in claim 35 wherein said bowl has an at least partially conical sidewall.

38. The bowl assembly defined in claim 35 wherein said guide member is a helical fin.

39. The bowl assembly defined in claim 35 wherein said bowl has a vertical orientation, said bowl having a bottom provided with a discharge port with a closure temporarily openable at intervals to discharge granular non-flowable solids.

40. The bowl assembly defined in claim 35 wherein said bowl has two conical portions provided at opposite ends of said bowl.

41. The bowl assembly defined in claim 35, further comprising a ribbon conveyor for transporting sediment along said inner surface of said bowl, said ribbon conveyor being located at a radial distance greater than that of said guide member and rotated at differential speed compared with said bowl.

42. The bowl assembly defined in claim 35, further comprising a conveyor disposed in said bowl for rotating at a differential speed relative to said bowl to transport deposited cake solids down an annular path formed between said guide member and said inner surface of said bowl.

43. The bowl assembly defined in claim 35 wherein said bowl has an orientation taken from the group comprising generally horizontal and generally vertical.

44. The bowl assembly defined in claim 35 wherein said path has a circumferential or annular component and an axial or longitudinal component, said circumferential or annular component being larger than said axial or longitudinal component.

45. The bowl assembly defined in claim 35, further comprising a plurality of solid-phase discharge ports disposed at axially spaced locations in said bowl.

46. The bowl assembly defined in claim 35 wherein baffles are disposed in said bowl along said guide member to force the suspension to flow substantially circumferentially in a predetermined direction.

47. The bowl assembly defined in claim 35, further comprising a plurality of rakes disposed in said bowl for rotating at a differential speed relative to said bowl to propel and agitate deposited solids to induce same to flow down an annular path formed between said guide member and said inner surface of said bowl.

48. The bowl assembly defined in claim 35 wherein said guide member is mounted from the two bowl heads respectively located at opposite ends of said bowl.

49. The bowl assembly defined in claim 35 wherein said guide member is fixed to a shaft disposed in said bowl coaxially with said axis.

50. The bowl assembly defined in claim 35 wherein said guide member is fixed to said inner surface of said bowl by studs.

51. A method for separating phases of a multiple phase slurry, comprising:
providing a bowl rotatable about an axis and a guide member disposed in said bowl, said guide member defining a first path having a substantial circumferential or annular component, said guide member having an outer edge spaced by a predetermined distance from an inner surface of said bowl;
rotating said bowl and said guide member about said axis;
during the rotating of said bowl and said guide member, introducing a suspension into said bowl;
during the rotating of said bowl and said guide member, sedimenting a solid phase from said slurry onto said inner surface of said bowl;
during the rotating of said bowl and said guide member and the sedimentation of the heavy phase, guiding said slurry or suspension which is depleted in heavy phase along said helical path towards a liquid phase discharge port in said bowl; and
moving the settled heavy phase along a second path substantially different from said first path.

52. The method defined in claim 51 wherein said second path is oriented at a substantial angle to said first path.

53. The method defined in claim 51 wherein said second path is generally along a steepest line of descent of said inner surface.
